(19) United States
(12) Patent Application Publication
(10) Pub. No.: US 2019/0140567 A1
(43) Pub. Date: May 9, 2019

(54) POWER SUPPLY DEVICE AND ELECTRIC DEVICE

(71) Applicant: Koki Holdings Co., Ltd., Tokyo (JP)

(72) Inventors: Hayato YAMAGUCHI, Ibaraki (JP); Eiji NAKAYAMA, Ibaraki (JP)

(73) Assignee: Koki Holdings Co., Ltd., Tokyo (JP)

(21) Appl. No.: 16/096,303

(22) PCT Filed: Mar. 31, 2017
(86) PCT No.: PCT/JP2017/013669

§ 371 Date: Oct. 25, 2018

(30) Foreign Application Priority Data
Apr. 28, 2016 (JP) 2016-090275

(51) Int. Cl. H02P 7/29; H01M 10/42

(52) U.S. Cl. CPC H02P 7/29; H01M 10/425; B24B 47/12; H01M 2010/4271; H01M 10/4207

(57) ABSTRACT

In order to provide a power supply device capable of supplying power to an electric device, predetermined control of which is performed upon detecting zero crossing, and an electric device which operates by receiving a supply of power from the power supply device, the power supply device 1 includes: a battery pack 10; a plug receptacle 8 for outputting a voltage of the battery pack 10; a switching component 14 disposed on a discharge path connected to the plug receptacle 8 from the battery pack 10; and a control part 13 for controlling the switching component 14. The control part 13 temporarily turns off the switching component 14 at a cycle twice that of a commercial power supply.

### TECHNICAL FIELD

The present invention relates to a power supply device which supplies power to an electric device using a voltage of a battery cell, and an electric device which operates by receiving power supply from the power supply device.

### BACKGROUND ART

Conventionally, an electric power tool driven by the electric power of a battery pack into which a secondary battery cell is built is known. Patent Literature 1 which will be described below discloses that a connection method of a plurality of battery packs (battery units) can be switched between, and a plurality of battery packs (for example, 18 V) are connected in series to obtain a DC voltage of 36 V. Further, Patent Literature 2 which will be described below discloses that four cell sets in which ten battery cells are connected in series are connected in series. In the case of a lithium-ion battery cell, a DC voltage of 3.6 V/cell×10 cells×4 sets=144 V can be obtained. In this way, when a predetermined number or more of battery packs (battery units) are connected in series, these can also be used as a power source for an electric device driven by a commercial power supply (for example, AC 100 V).

### CITATION LIST

### Patent Literature

### [Patent Literature 1]

Japanese Unexamined Patent Application Publication No. 2014-017954

### [Patent Literature 2]

Japanese Unexamined Patent Application Publication No. 2014-036565

### SUMMARY OF INVENTION

### Technical Problem

Since the voltage output from the power supply device described in each of Patent Literature 1 and 2 is direct current, when an electric device driven by a commercial power supply is connected and used, there are restrictions on the electric devices which can be used. For example, an electric power tool which detects zero crossing of an AC input voltage and performs predetermined control (for example, phase control), such as a grinder cannot be used.

The present invention has been made in recognition of such a situation, and an objective thereof is to provide a power supply device capable of supplying power to an electric device which detects zero crossing to perform predetermined control, and an electric device which operates by receiving power supply from the power supply device.

### Solution to Problem

One aspect of the present invention is a power supply device. The power supply device includes battery cells, an output terminal electrically connected to the battery cell, a switching component provided in a discharge path leading from the battery cell to the output terminal, and a control part which controls the switching component, wherein the control part temporarily turns off the switching component using a cycle twice that of a commercial power supply.

The cycle may be 100 Hz or 120 Hz.

The control part may be capable of switching the cycle between 100 Hz and 120 Hz.

The control part may change a temporary off time of the switching component or a duty ratio of ON/OFF control of the switching component according to a voltage of the battery cell.

The control part may increase the off time or may reduce the duty ratio when a voltage of the battery cell within a predetermined voltage range is higher as compared with a case in which the voltage is lower.

The control part may switch an effective value of an output voltage of the power supply device between a case in which the voltage of the battery cell is in a first voltage range which is a predetermined value or more and a case in which it is in a second voltage range which is less than the predetermined value by adjusting the off time or the duty ratio.

Another aspect of the present invention is a power supply device capable of driving an electric device operating in a phase control manner, wherein an output is temporarily stopped at a cycle twice that of a commercial power supply.

The cycle may be 100 Hz or 120 Hz.

The cycle may be capable of being switched between 100 Hz and 120 Hz.

Another aspect of the present invention is an electric device which is operated by receiving power supply from the power supply device.

It may comprise a motor and drive the motor by a phase control method.

In addition, any combination of the above components, and those obtained by converting representations of the present invention among methods, systems and so on are also effective as an aspect of the present invention.

### Advantageous Effects of Invention

According to the present invention, it is possible to provide a power supply device capable of supplying power to an electric device which detects zero crossing to perform predetermined control, and an electric device which operates by receiving power supply from the power supply device.

### BRIEF DESCRIPTION OF DRAWINGS

FIG. 1 is an exterior view of a power supply device 1 according to an embodiment of the present invention, FIG. 1(A) is a plan view, FIG. 1(B) is a front view, and FIG. 1(C) is a right side view.

FIG. 2 is an exterior view of the power supply device 1 in a state in which a battery pack 10 is mounted, FIG. 1(A) is a plan view, FIG. 1(B) is a front view, and FIG. 1(C) is a right side view.

FIG. 3 is an exterior view of the power supply device 1 and an electric power tool 2 connected thereto.

FIG. 4 is a circuit block diagram of the power supply device 1.

FIG. 5 is a circuit block diagram of the electric power tool 2 connected to the power supply device 1.

FIG. 6 is a control flowchart of the power supply device 1.

FIG. 7 is a control flowchart of the electric power tool 2.

FIG. 8 is a graph showing a relationship between an operation amount (set voltage) of a speed setting dial 22 and a conduction angle of a triac 26 in the electric power tool 2.

FIG. 9 is a waveform diagram showing an example of a 50 Hz sine wave (commercial AC voltage), an output voltage of the power supply device 1, and a zero crossing detection signal of the electric power tool 2.

FIG. 10 is a graph showing an example of a relationship between a total output voltage of battery packs 10 connected in series and an on-time of the switching component 14 per cycle in a case in which a cycle of the output voltage of the power supply device 1 is 10 ms (a set frequency is 50 Hz).

### DESCRIPTION OF EMBODIMENTS

Hereinafter, a preferred embodiment of the present invention will be described in detail with reference to the drawings. The same or equivalent elements, members, processes, and so on shown in the respective drawings are designated by the same reference numerals, and redundant description will be omitted as appropriate. In addition, the embodiment does not limit the invention and is an example, and all the features and combinations thereof described in the embodiment are not necessarily essential to the invention.

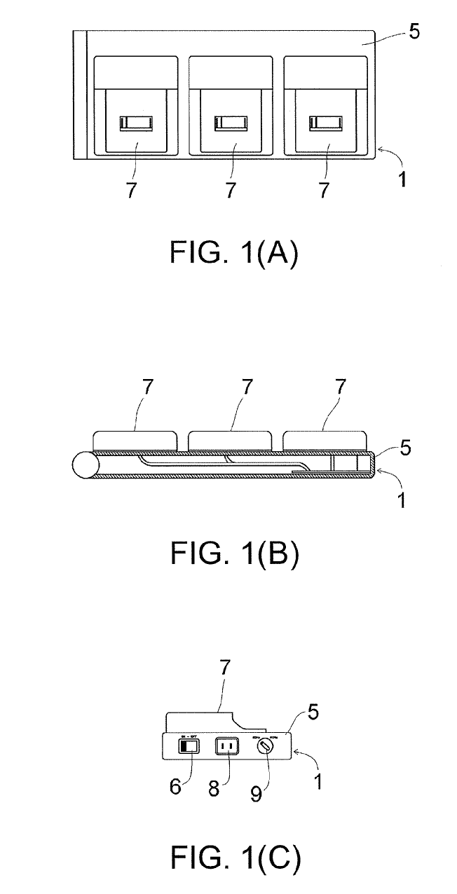

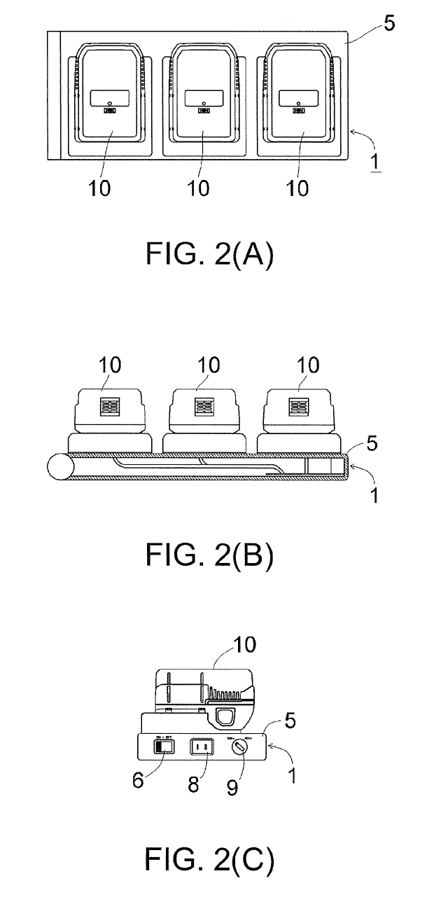

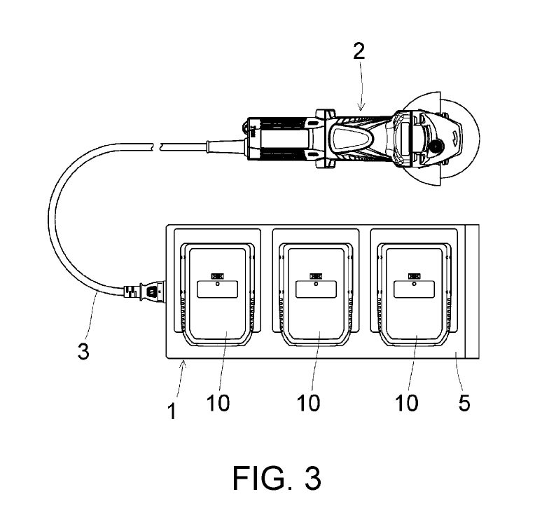

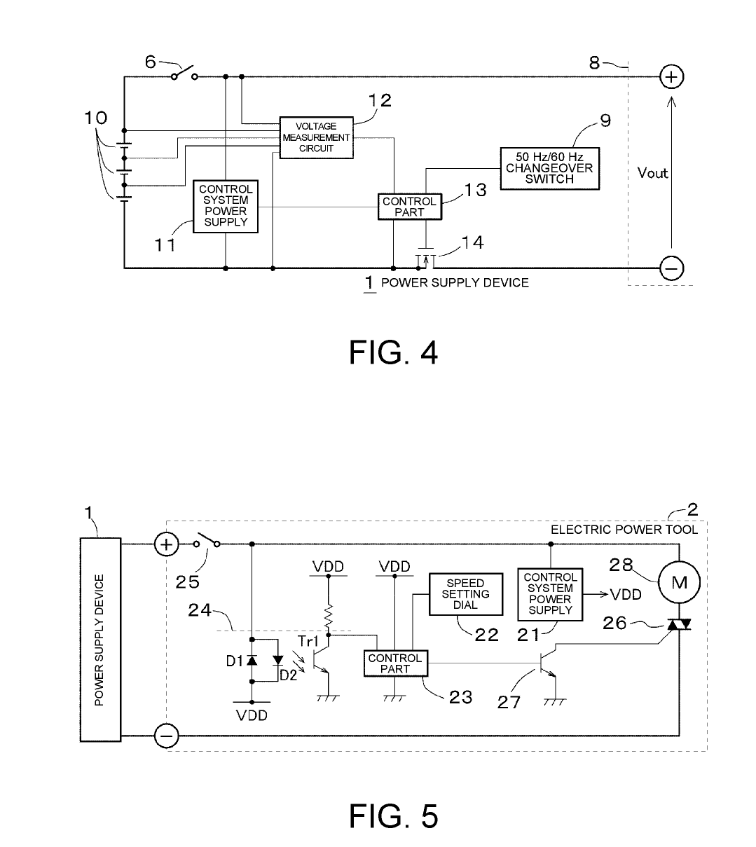

As shown in FIGS. 1(A) to 1(C), a power supply device 1 of the embodiment has a plurality of (three in the illustrated example) battery pack mounting portions 7 on an upper surface of a housing 5. As shown in FIGS. 2(A) to 2(C), a battery pack 10 can be detachably mounted on each of the battery pack mounting portions 7. A power switch 6, a plug receptacle 8 as an output terminal, and a 50 Hz/60 Hz changeover switch 9 as a frequency switching means are provided on a right side surface of the housing 5. The power switch 6 is a switch for a user to switch driving and stopping of the power supply device 1. The plug receptacle 8 is a portion into which a plug of a power cord 3 (FIG. 3) is inserted. As shown in FIG. 3, power can be supplied from the power supply device 1 to an electric power tool 2 by the power cord 3 connected to the plug receptacle 8. In addition, in the example shown in FIG. 3, the electric power tool 2 is a grinder. The 50 Hz/60 Hz changeover switch 9 is a switch for the user to switch a frequency of an output voltage of the power supply device 1. A control system power supply 11, a voltage measurement circuit 12, a control part 13 such as a microcomputer, and a switching component 14 such as an FET as shown in FIG. 4 are provided inside the housing 5.

As shown in FIG. 4, in the power supply device 1, three battery packs 10 are connected in series. Each of the battery packs 10 has a constitution in which, for example, ten 3.6 V secondary battery cells are connected in series, and a rated output voltage thereof is 36 V. In this case, the power supply device 1 has a constitution in which 30 secondary battery cells are connected in series. A maximum voltage of 120 V appears at both ends of the three battery packs 10 connected in series according to a remaining capacity of each of the battery packs 10.

The power switch 6 is provided in a discharge path leading from a plus side of the series connection of the battery packs 10 to a plus terminal of the plug receptacle 8. The control system power supply 11 generates a direct current voltage of, for example, 5 V which is an operation voltage of the control part 13, on the basis of the output voltage of the battery packs 10 (output-side voltage of the power switch 6). The voltage measurement circuit 12 measures the output voltage of each of the battery packs 10 and the output-side voltage of the power switch 6 and transmits a result to the control part 13. The control part 13 controls ON/OFF of the switching component 14 (for example, PWM control), as described later, on the basis of the frequency set by the 50 Hz/60 Hz changeover switch 9 and the output voltage of the battery packs 10 measured by the voltage measurement circuit 12. The switching component 14 is provided in a discharge path leading from a minus side of the series connection of the battery packs 10 to a minus terminal of the plug receptacle 8.

The electric power tool 2 shown in FIGS. 3 and 5 is an example of an electric device which operates in a phase control manner, and a rotation speed of a motor 28 can be adjusted by controlling the conduction angle of the triac 26 connected in series to the motor 28. As shown in FIG. 5, the electric power tool 2 switches between driving and stopping of the motor 28 (presence or absence of power supply to the motor 28) by operating a trigger switch 25 and has a photocoupler 24 which detects zero crossing of an input voltage via the trigger switch 25. The photocoupler 24 includes a pair of light emitting diodes D1 and D2 and a phototransistor Tr1 and transmits a zero crossing detection signal, which reaches a high level only during a period when the input voltage via the trigger switch 25 is close to 0, to a control part 23 by stopping emission of light from both the light emitting diodes D1 and D2 and turning off the phototransistor Tr1 during the period.

A control system power supply 21 generates an operation voltage VDD (for example, a DC voltage of 5 V) of the control part 23 on the basis of the input voltage via the trigger switch 25. A speed setting dial 22 is an example of a speed setting means, and is provided to allow the user to set the rotation speed of the motor 28. The control part 23 controls turning the switching component 27 ON/OFF and controls the conduction angle of the triac 26 on the basis of the zero crossing detection signal from the photocoupler 24 and a speed setting value (speed setting voltage) due to the speed setting dial 22.

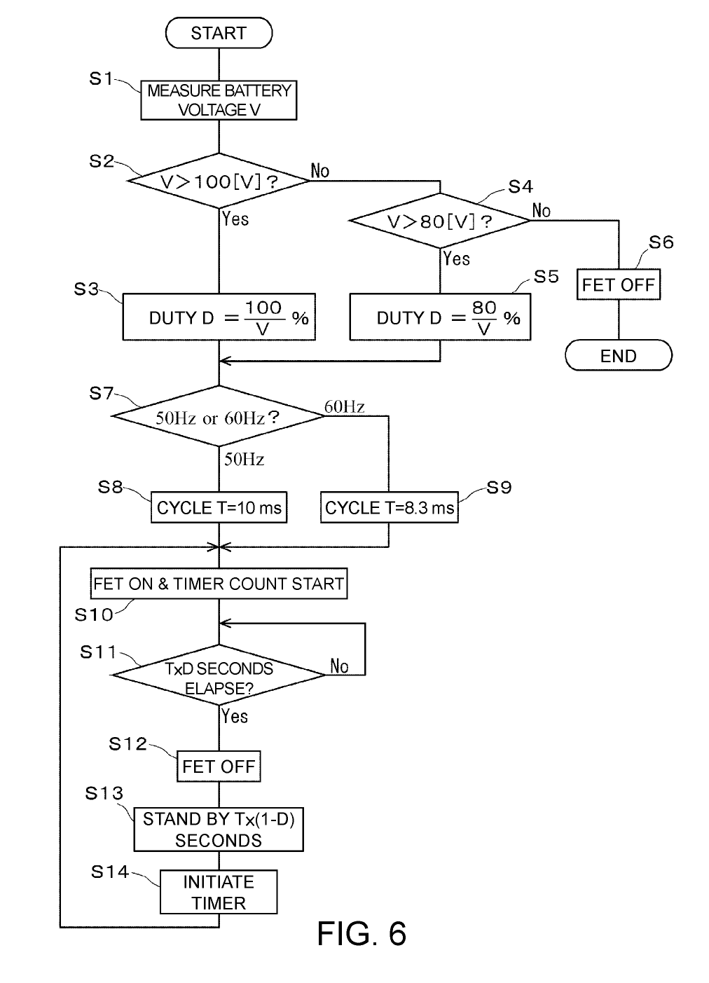

FIG. 6 is a control flowchart of the power supply device 1. This flowchart is started by the user turning on the power switch 6 in a state in which each of the battery packs 10 is mounted on all the battery pack mounting portions 7 of the power supply device 1. The control part 13 detects the output-side voltage V (the output voltage V of the battery packs 10 connected in series) of the power switch 6 due to an output signal of the voltage measurement circuit 12 (S1). When the detected voltage V exceeds 100 V (S2, Yes), the control part 13 sets a duty ratio D of the ON/OFF control (PWM control) of the switching component 14 to 100/V[%] (S3). This means that a target effective value of the output voltage of the power supply device 1 is set to 100 V. When the detected voltage V is 100 V or less (S2, No) and exceeds 80 V (S4, Yes), the control part 13 sets the duty ratio D to 80/V[%] (S5). This means that the target effective value of the output voltage of the power supply device 1 is set to 80 V. When the detected voltage V is 80 V or less, the control part 13 turns off the switching component 14 (S6) and does not output a voltage from the plug receptacle 8. This is in consideration of the possibility that the AC driven electric device may not operate normally when the output voltage is less than 80 V.

Subsequently, the control part 13 confirms a set frequency due to the 50 Hz/60 Hz changeover switch 9 (S7), sets a cycle T of the ON/OFF control (PWM control) of the switching component 14 to 10 ms (S8) when the set frequency is 50 Hz (S7, Yes), and sets the cycle T to 8.3 ms (−1,000 ms/120) (S9) when the set frequency is 60 Hz (S7, No). This is a setting according to a fact that the zero-crossing occurs at a frequency of 100 Hz (a cycle of 10 ms) in a 50 Hz sine wave and the zero crossing occurs at a frequency of 120 Hz (a cycle of 8.3 ms) in a 60 Hz sine wave. In addition, a process related to the setting of the cycle T may be performed prior to or in parallel with the process related to the setting of the duty ratio D.

When the setting of the duty ratio D and the cycle T is completed, the control part 13 turns on the switching component 14 and starts timer counting (S10). The control part 13 maintains the switching component 14 in an ON state (S11, No) until T×D seconds have elapsed since the switching component 14 was turned on and then turns off the switching component 14 (S12) when the T×D seconds have elapsed since the switching component 14 was turned on (S11, Yes). The control part 13 maintains the switching component 14 in an OFF state, stands by T×(1-D) seconds (S13), initializes the timer (S14) and returns to Step S10. An output voltage appears at the plug receptacle 8 of the power supply device 1 by repeating the operations of Steps S10 to S14.

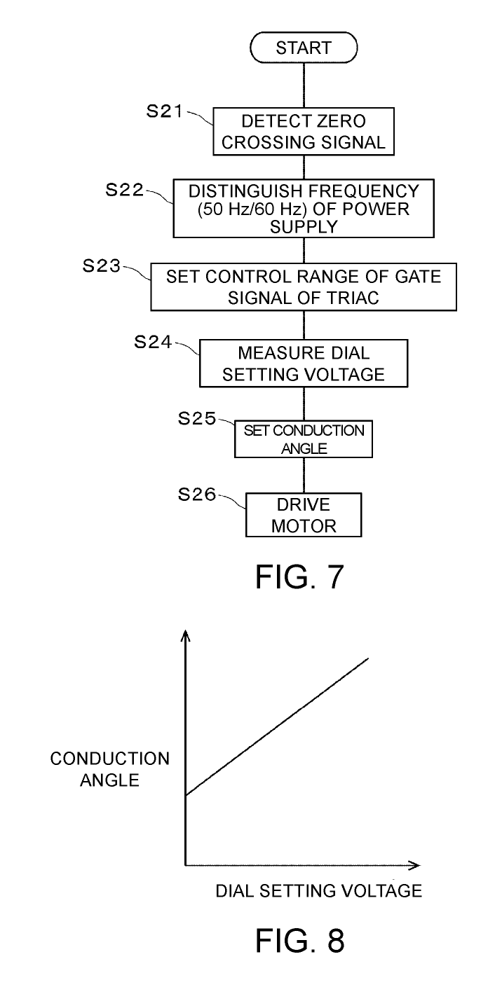

FIG. 7 is a control flowchart of the electric power tool 2. The control part 23 detects the zero-crossing detection signal from the photocoupler 24 (S21) and distinguishes the frequency (50 Hz/60 Hz) of the output voltage of the power supply device 1 input via the trigger switch 25 (S22). The control part 23 sets a control range of a gate signal of the triac 26 according to the distinguished frequency (S23). Meanwhile, the control part 23 measures a speed setting voltage due to the speed setting dial 22 (S24) and sets the conduction angle of the triac 26 on the basis of the speed setting voltage (S25). An example of a relationship between the speed setting voltage (dial setting voltage) and the conduction angle is shown in FIG. 8. In addition, the conduction angle setting process may be performed prior to or in parallel with the process of setting the control range of the gate signal of the triac 26. The control part 23 controls the ON/OFF of the switching component 27 (that is, ON/OFF of the triac 26) to energize the motor 28 and controls the motor 28 at a constant speed (S26) on the basis of the control range set in Step S23 and the conduction angle set in Step S25.

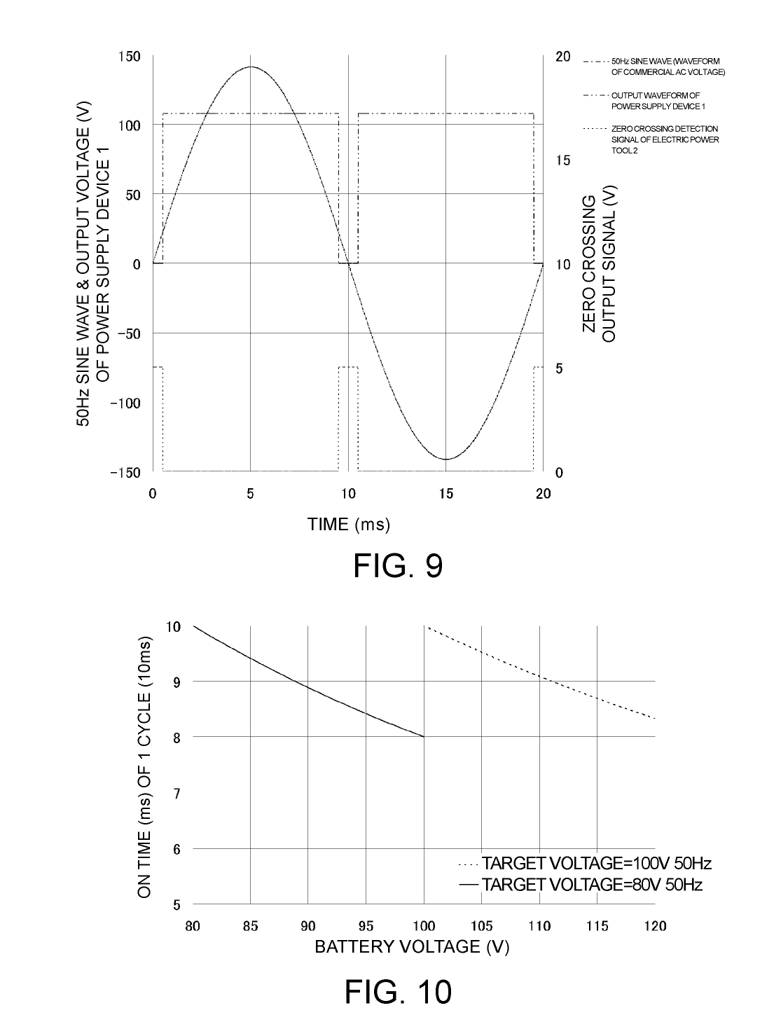

FIG. 9 is a waveform diagram showing an example of the 50 Hz sine wave (commercial AC voltage), the output voltage of the power supply device 1, and the zero crossing detection signal of the electric power tool 2. As shown in FIG. 9, the output voltage of the power supply device 1 temporarily becomes zero with the same cycle as the zero-crossing generation cycle of the sine wave of the set frequency (50 Hz in the illustrated example) by the control shown in FIG. 6, and also the effective value is controlled to 100 V or 80 V (100 V in the illustrated example) according to the output-side voltage of the power switch 6. Additionally, in the electric power tool 2, the photocoupler 24 generates the zero crossing detection signal during a period when the output voltage of the power supply device 1 temporarily becomes zero.

FIG. 10 is a graph showing an example of a relationship between a total output voltage of the battery packs 10 connected in series and an on-time of the switching component 14 per cycle in a case in which the cycle of the output voltage of the power supply device 1 is 10 ms (the set frequency is 50 Hz). In the power supply device 1, a range from more than 100 V to 120 V is defined as a first voltage range, a range from more than 80 V to 100 V is set as a second voltage range, the target effective value of the output voltage is set to 100 V in the first voltage range, and the target effective value of the output voltage is set to 80 V in the second voltage range. Switching of the target effective value is performed by changing a temporary off time of the switching component 14 per cycle, that is, the duty ratio D of the ON/OFF control of the switching component 14. Further, in each of the first and second voltage ranges, even when the total output voltage of the battery packs 10 changes, the effective value of the output voltage of the power supply device 1 is controlled to be constant by increasing the temporary off time of the switching component 14 per cycle, that is, reducing the duty ratio D of the ON/OFF control of the switching component 14 as the total output voltage of the battery packs 10 connected in series increases.

According to the embodiment, the following effects can be obtained.

(1) In the power supply device 1, since the control part 13 temporarily turns off the switching component 14 provided in the discharge path leading from the battery packs 10 to the plug receptacle 8 with a predetermined cycle, that is, with a cycle (100 Hz or 120 Hz) twice that of a commercial power supply, the electric device such as the electric power tool 2 which operates with the output voltage of the power supply device 1 can detect the zero crossing in a pseudo way at the timing when the switching component 14 is turned off and can perform predetermined control such as phase control using the zero crossing. Therefore, the power supply device 1 enables power supply to the electric device which detects the zero crossing to perform predetermined control.

(2) Since the control part 13 adjusts the temporary off time of the switching component 14 per cycle, that is, the duty ratio D of the ON/OFF control of the switching component 14 and thus controls the effective value of the output voltage from the power supply device 1 to 100 V or less even when the total output voltage of the battery packs 10 exceeds 100 V, it is possible to suppress the output of the voltage having an effective value larger than AC 100 V, and thus it is possible to suppress the electric device such as the electric power tool 2 as a power supply destination not operating properly or circuit components inside the electric device being damaged.

(3) Since the control part 13 adjusts the temporary off time of the switching component 14 per cycle, that is, the duty ratio D of the ON/OFF control of the switching component 14 according to the total output voltage of the battery packs 10 and thus controls the effective value of the output voltage of the power supply device 1 to be constant in each of the case in which the total output voltage of the battery packs 10 is in the first voltage range from more than 100 V to 120 V and the case in which it is in the second voltage range from more than 80 V to 100 V, it is possible to suppress the change in feeling of use of the electric device such as the electric power tool 2 as the power supply destination according to the change in the total output voltage of the battery packs 10 due to the change in the remaining capacity of the battery packs 10.

(4) Since the control part 13 sets the target effective value of the output voltage of the power supply device 1 to 100 V when the total output voltage of the battery packs 10 exceeds 100 V and also switches the target effective value to 80 V when the total output voltage of the battery packs 10 becomes 100 V or less, the power supply can be continued with the output voltage having an effective value of 80 V at which most of the AC driven electric devices operate normally even when the total output voltage of the battery packs 10 drops to 100 V or less.

Although the present invention has been described with reference to the embodiment, it is understood by those skilled in the art that various modifications can be made to each element and each processing process of the embodiment within the range described in the claims. A modified example will be described below.

In the embodiment, the electric power tool 2 such as a grinder is exemplified as the electric device which operates in the phase control method, but the electric device is not limited to the electric power tool and may be another type such as a dimmer for illumination or a temperature regulator for a heat source. The specific numbers shown in the embodiment, such as the ON/OFF cycle or the duty ratio of the switching component 14, the number of the battery packs 10 or the total output voltage thereof, and the target effective value of the output voltage of the power supply device 1 are merely examples, and they may be appropriately set in accordance with required specifications.

### REFERENCE SIGNS LIST

1 Power supply device

2 Electric power tool (electric device)

3 Power cord

5 Housing

6 Power switch

7 Battery pack mounting portion

8 Plug receptacle (output terminal)

9 50 Hz/60 Hz changeover switch (frequency switching means)

10 Battery pack

11 Control system power supply

12 Voltage measurement circuit

13 Control part

14 Switching component

21 Control system power supply

22 Speed setting dial

23 Control part

24 Photocoupler (zero crossing detection means)

25 Trigger switch

26 Triac (switching component)

27 Switching component

28 Motor

1. A power supply device comprising:
battery packs which have battery cells;
an output terminal electrically connected to the battery cell;
a switching component provided in a discharge path leading from the battery cell to the output terminal; and
a control part which controls the switching component,
wherein a plurality of the battery packs having a rated output voltage of 36 V are connected in series,
the control part temporarily turns off the switching component using a cycle twice that of a commercial power supply.

2. The power supply device according to claim 1, wherein the cycle is 100 Hz or 120 Hz.

3. The power supply device according to claim 1, wherein the control part is capable of switching the cycle between 100 Hz and 120 Hz.

4. The power supply device according to claim 1, wherein the control part changes a temporary off time of the switching component or a duty ratio of ON/OFF control of the switching component according to a voltage of the battery cell.

5. The power supply device according to claim 4, wherein the control part increases the off time or reduces the duty ratio when a voltage of the battery cell within a predetermined voltage range is higher as compared with a case in which the voltage is lower.

6. The power supply device according to claim 4, wherein the control part switches an effective value of an output voltage of the power supply device between a case in which the voltage of the battery cell is in a first voltage range which is a predetermined value or more and a case in which it is in a second voltage range which is less than the predetermined value by adjusting the off time or the duty ratio.

7. A power supply device capable of driving an electric device operating in a phase control manner,
wherein a plurality of battery packs having a rated output voltage of 36 V are connected in series,
an output is temporarily stopped at a cycle twice that of a commercial power supply.

8. The power supply device according to claim 7, wherein the cycle is 100 Hz or 120 Hz.

9. The power supply device according to claim 8, wherein the cycle is capable of being switched between 100 Hz and 120 Hz.

10. An electric device which is operated by receiving power supply from the power supply device according to claim 1.

11. The electric device according to claim 10, wherein the electric device comprises a motor and drive the motor by a phase control method.

12. The power supply device according to claim 1, wherein the three battery packs are connected in series.

13. The power supply device according to claim 7, wherein the three battery packs are connected in series.
